(19) United States
(12) Patent Application Publication
(10) Pub. No.: US 2026/0149511 A1
(43) Pub. Date: May 28, 2026

(54) METHOD FOR MEASURING ANTENNA REFLECTION COEFFICIENT AND USER EQUIPMENT USING THE SAME

(71) Applicant: MEDIATEK INC., Hsinchu City (TW)

(72) Inventors: Li-Shan Cheng, Hsinchu City (TW); David Stephen Ivory-Cave, Cambridge (GB); Vivek Roy, Cambridge (GB); Bernard Mark Tenbroek, Cambridge (GB); Kuo-Hao Chen, Hsinchu City (TW)

(21) Appl. No.: 19/398,160

(22) Filed: Nov. 24, 2025

Related U.S. Application Data
(60) Provisional application No. 63/725,029, filed on Nov. 26, 2024.

(51) Int. Cl. H04B 17/10; H04B 17/21

(52) U.S. Cl. CPC H04B 17/103; H04B 17/21

(57) ABSTRACT

A method for measuring an antenna reflection coefficient of an antenna and a user equipment using the same are provided. The method for measuring the antenna reflection coefficient comprises the following steps. At least two receiving signals are measured. Each of the at least two receiving signals is measured under different tuner measurement control words. A plurality of tuner scattering parameters and a front-end reflection coefficient under a receiver (Rx) frequency are obtained. The plurality of tuner scattering parameters correspond to the different tuner measurement control words. The antenna reflection coefficient is calibrated according to the at least two receiving signals, the tuner scattering parameters and the front-end reflection coefficient.

This application claims the benefit of U.S. Provisional application Ser. No. 63/725,029, filed Nov. 26, 2024, the disclosure of which is incorporated by reference herein in its entirety.

### TECHNICAL FIELD

The disclosure relates in general to a method for measuring a coefficient and a user equipment using the same, and a method for measuring an antenna reflection coefficient and a user equipment using the same.

### BACKGROUND

In communication systems, accurately measuring the antenna reflection coefficient (Γ_{Ant}) is crucial for ensuring efficient signal transmission and reception. The antenna reflection coefficient indicates how much of the transmitted signal is reflected back due to impedance mismatches between the antenna and the transmission line. A high reflection coefficient leads to signal loss, reduced efficiency, and potential damage to components. Therefore, by accurately measuring antenna reflection coefficient, the antenna performance can be improved, the power waste can be reduced, and overall system reliability and data throughput can be enhanced.

Traditionally, measuring antenna reflection coefficient necessitates the antenna to be connected with the transmitter (Tx). However, the majority of antennas in mobile devices are solely connected with the receiver (Rx) and do not interface with the transmitter, thereby limiting their tuning capabilities. This architecture makes it challenging to monitor and adjust the antenna performance in real time, especially under varying environmental conditions or usage scenarios. As a result, traditional methods fall short in adapting antenna behavior dynamically, which is critical for maintaining optimal communication quality in modern mobile devices.

### SUMMARY

The disclosure is directed to a method for measuring an antenna reflection coefficient and a user equipment using the same. The measurement of the antenna reflection coefficient utilizes the receiving signals. This innovative approach enables the implementation of close-loop antenna tuning (CLAT) across all antennas in mobile devices, irrespective of their connection to the transmitter (Tx). By leveraging the received signal for measurement, this method overcomes the traditional limitations and enhances the tuning precision and efficiency of mobile antennas. Further, the measurement could not suffer from variation, such as part-to-part variation and temperature change. Moreover, the antenna reflection coefficient could be directly measured under receiver (Rx) frequency in real-time scenario.

According to one embodiment, a method for measuring an antenna reflection coefficient of an antenna is provided. The method for measuring the antenna reflection coefficient comprises the following steps. At least two receiving signals are measured. Each of the at least two receiving signals is measured under different tuner measurement control words. A plurality of tuner scattering parameters and a front-end reflection coefficient under a receiver (Rx) frequency are obtained. The plurality of tuner scattering parameters correspond to the different tuner measurement control words. The antenna reflection coefficient is calibrated according to the at least two receiving signals, the tuner scattering parameters and the front-end reflection coefficient.

According to another embodiment, a user equipment is provided. The user equipment comprises an antenna, a tuner, an RF Front-end circuit and a receiving (Rx) Modem. The antenna has an antenna reflection coefficient. The tuner is connected to the antenna. The tuner is used for switching different tuner measurement control words. The RF Front-end circuit is connected to the tuner. The Rx modem is connected to the RF Front-end circuit. The Rx modem is used for measuring at least two receiving signals. Each of the at least two receiving signals is measured under different tuner measurement control words. The Rx modem is used for calibrating the antenna reflection coefficient according to the at least two receiving signals, plurality of tuner scattering parameters and a front-end reflection coefficient.

### BRIEF DESCRIPTION OF THE DRAWINGS

FIG. 1 shows a schematic diagram of a user equipment according to one embodiment of the present disclosure.

FIG. 2 shows a plurality of tuner scattering parameters according to one embodiment of the present disclosure.

FIG. 3 shows the measurement of the tuner scattering parameters according to one embodiment of the present disclosure.

FIG. 4 illustrates a front-end reflection coefficient according to one an embodiment of the present disclosure.

FIG. 5 illustrates a tuner reflection coefficient according to one an embodiment of the present disclosure.

FIG. 6 shows the measurement of the front-end reflection coefficient according to one embodiment of the present disclosure.

FIG. 7 shows a tuner impedance matrix in a tuner according to one embodiment of the present disclosure.

FIG. 8 illustrates the selection of a plurality of tuner measurement control words according to one embodiment of the present disclosure.

FIG. 9 shows a flowchart of a method for measuring the antenna reflection coefficient of the antenna according to one embodiment of the present disclosure.

FIG. 10 shows a flowchart of a method for measuring the antenna reflection coefficient of the antenna according to another embodiment of the present disclosure.

FIG. 11 illustrates hardware features for executing the automatic tuner measurement control word switching according to one embodiment of the present disclosure.

FIG. 12 illustrates a clock calibration for the automatic tuner measurement control word switching according to one embodiment of the present disclosure.

FIG. 13 illustrates Receiver Close-Loop Antenna Tuning (RxCLAT) according to one embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

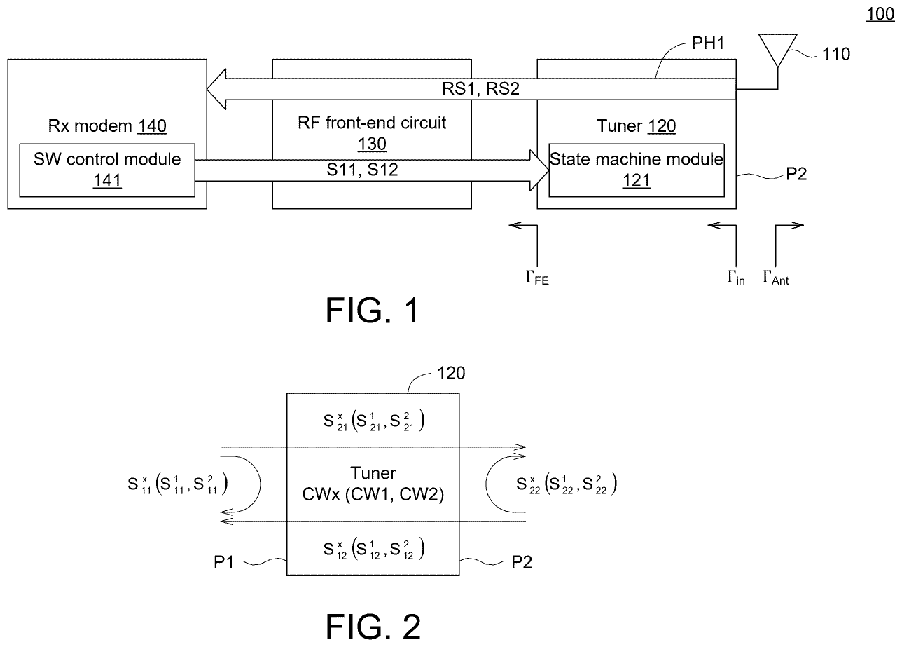

Please refer to FIG. 1, which shows a schematic diagram of a user equipment 100 according to one embodiment of the present disclosure. The user equipment 100 is, for example, a cellphone, a laptop, a Modem (modulator-demodulator) chip or a communication chip embedded in a mobile device, a robot and/or a vehicle.

The user equipment 100 includes, for example, an antenna 110, a tuner 120, an RF Front-end circuit 130 and a receiving (Rx) modem 140. In the user equipment 100, the antenna 110 serves as the interface between electromagnetic waves in the air and the electrical signals in a circuit. The antenna 110 is, for example but not limited to, a dipole antenna, a monopole antenna, a patch antenna, a helical antenna, a Yagi-Uda antenna, and/or a phased array antenna. The dipole antenna consists of two metal rods. The monopole antenna has a single conductor, and is often mounted over a ground plane. The patch antenna is flat, and used in mobile and/or IoT devices. The helical antenna is coil-shaped, and is good for circular polarization. The Yagi-Uda antenna is directional, and is used in TV and point-to-point links. The phased array antenna has beam-steering, and is used in radar and 5G systems.

The tuner 120 may be coupled to the antenna 110. The tuner 120 may be the first stage after the antenna 110. The tuner 120 is used to select a specific frequency or channel from the broad range of received RF signals. It adjusts the receiver circuit to match the desired signal frequency and often includes filtering and amplification. The tuner 120 is, for example but not limited to, an analog tuner, a digital tuner, a wideband tuner and/or a closed-loop tuner. The analog tuner is manually tuned using variable capacitors or inductors. The digital tuner is electronically controlled, and use PLL (phase-locked loop) for precise tuning. The wideband tuner could cover a large range of frequencies without switching components. The closed-loop tuner could be adjusted in real time based on feedback from signal quality metrics.

The RF front-end circuit 130 may be coupled to the tuner 120. The tuner 120 may be coupled between the antenna 110 and the RF front-end circuit 130. The RF front-end circuit 130 processes the raw RF signal by filtering, amplifying, and converting it to an intermediate frequency (IF) or baseband for demodulation. The RF front-end circuit 130 may comprise a low-noise amplifier (LNA), a bandpass filter, a mixer and/or a switch/duplexer. The LNA is used to boost weak signals with minimal added noise. The bandpass filter is used to select the desired frequency band and reject out-of-band noise. The mixer is used to convert RF to a lower frequency (IF) by mixing it with a local oscillator signal. The switch/duplexer is used to separate Tx and Rx paths, especially in full-duplex systems.

The RF front-end circuit 130 is, for example, but not limited to, a discrete RF front-end, an integrated front-end module (FEM) and/or a software-defined RF front-end. The discrete RF front-end is made from separate components, and is customizable. The integrated front-end module is compact modules used in smartphones, Wi-Fi, etc. The software-defined RF front-end allows dynamic reconfiguration for different bands and standards.

The Rx modem 140 is used to demodulate the incoming signal-extracting digital data from the analog waveform. It also handles error correction, synchronization, and decoding. The Rx modem 140 is, for example but not limited to, an ASK/FSK/PSK demodulator, a QAM demodulator, an OFDM demodulator and/or a software-defined modem. The ASK/FSK/PSK demodulator is used in simple digital systems like RFID or low-power IoT. The QAM demodulator is common in high-speed data systems like LTE and Wi-Fi. The OFDM demodulator is used in modern broadband systems (4G/5G, Wi-Fi). The software-defined modem is implemented in DSP or FPGA, and supports multiple modulation types.

As shown in the FIG. 1, there are an antenna reflection coefficient Γ_{Ant}, a front-end reflection coefficient Γ_{FE} and a tuner reflection coefficient Γᵢₙ.

The antenna reflection coefficient Γ_{Ant} measures how much of the incoming signal is reflected back due to impedance mismatch between the antenna and the connected circuitry (typically the RF front-end). It's a key indicator of how efficiently the antenna is transferring power to the system. The low reflection coefficient Γ_{Ant} means good impedance matching (minimal signal loss). A high reflection coefficient Γ_{Ant} means poor matching (more signal is reflected back).

The front-end reflection coefficient Γ_{FE} represents how much signal is reflected at the input of the RF front-end circuit 130 due to mismatch with the antenna 110 or the tuner 120. Even if the antenna 110 is well-designed, a mismatch at the RF front-end circuit 130 could still degrade system performance.

The tuner reflection coefficient Γᵢₙ refers to the reflection coefficient at a second tuner port P2. The tuner reflection coefficient Γᵢₙ means how well the tuner 120 is compensating for mismatch conditions.

The Rx modem 140 includes a software (SW) control module 141. The SW control module 141 is a hardware implementation of a software control which can be achieved through various options, including but not limited to Mobile Industry Processor Interface Radio Frequency Front-End (MIPI RFFE).

The tuner 120 includes a state machine module 121. The state machine module 121 is a hardware implementation of a state machine which can be achieved through various options, including but not limited to Microcontroller, Complex Programmable Logic Device (CPLD), and Field-Programmable Gate Array (FPGA).

This disclosure provides a method for measuring the antenna reflection coefficient Γ_{Ant} utilizing the received signals. Furthermore, this innovative approach enables the implementation of CLAT across all antennas in mobile devices, irrespective of their connection to the transmitter (Tx).

The measurement of the antenna reflection coefficient Γ_{Ant} using the receiving signals measured by the receiver (Rx) could be performed offline, real-time, or in a hybrid mode, depending on the hardware capabilities and user requirements.

For example, required data for the measurement of the antenna reflection coefficient Γ_{Ant} includes at least two receiving signals RS1, RS2 and a plurality of tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2}$$

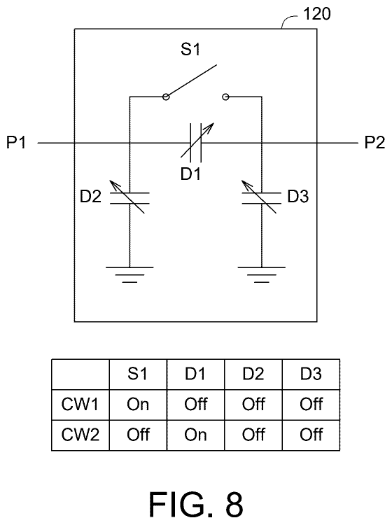

(shown in FIG. 2) corresponding to a plurality of tuner measurement control words CW1, CW2 shown in FIG. 8). The at least two receiving signals RS1, RS2 may be transmitted from the antenna 110 through the tuner 120 and the RF front-end circuit 130, and then to the Rx modem 140. The at least two receiving signals RS1, RS2 are measured by Rx modem 140 under different tuner measurement control words CW1, CW2. The tuner scattering parameters

$${S}_{11}^{1} , {S}_{21}^{1} , {S}_{12}^{1} , {S}_{22}^{1}$$

corresponding the tuner measurement control word CW1 and the tuner scattering parameters

$${S}_{11}^{2} , {S}_{21}^{2} , {S}_{12}^{2} , {S}_{22}^{2}$$

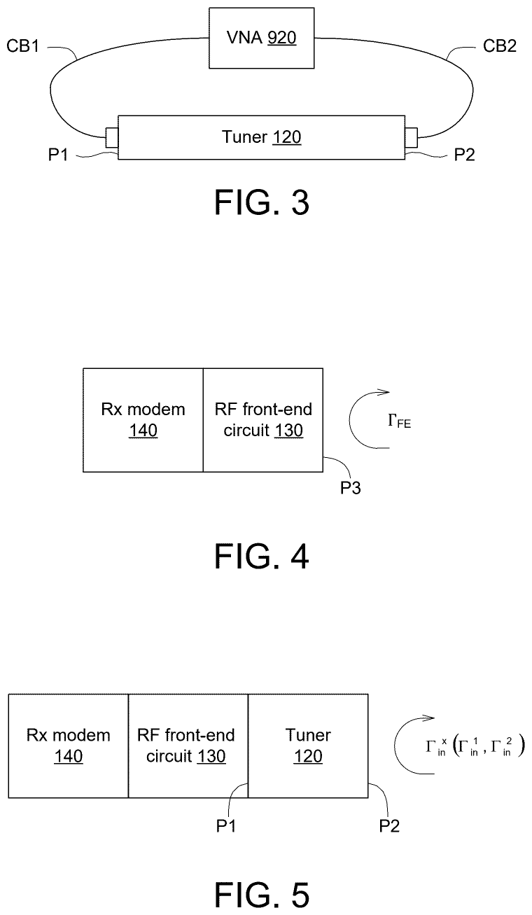

corresponding the tuner measurement control word CW2 could be estimated by using offline simulation or measured by equipment, such as a vector network analyzer (VNA) 920 (shown in FIG. 3). In some embodiments, the tuner 120 can perform measurements to obtain the scattering parameters before being connected to the antenna 110 and the RF front-end circuit 130. In some embodiments, the at least two receiving signals RS1, RS2 are measured different tuner measurement control words CWx after the tuner 120 has been connected to the antenna 110 and the RF front-end circuit 130. In some embodiments, please refer to FIGS. 2 and 8, the tuner 120 can be configured to perform measurements under different states (e.g., using tuner measurement control words CW1 and CW2) to obtain the corresponding tuner scattering parameters. For example, the tuner 120 can perform measurements to obtain the scattering parameters before being connected to the antenna 110 and the RF front-end circuit 130. In some embodiments, the tuner 120 is first set to the first state via the tuner measurement control word CW1 to measure and obtain the scattering parameters

$${S}_{11}^{1} , {S}_{21}^{1} , {S}_{12}^{1} , {S}_{22}^{1} .$$

Then, the tuner 120 is set to the second state via the tuner measurement control word CW2 to measure and obtain the scattering parameters

$${S}_{11}^{2} , {S}_{21}^{2} , {S}_{12}^{2} , {S}_{22}^{2} .$$

After completing these steps, the tuner 120 is connected to the antenna 110 and the RF front-end circuit 130. Subsequently, the tuner 120 is set to the first state via the tuner measurement control word CW1, and the antenna 110 transmits a signal. The receiving signal RS1 is generated via the tuner 120 in the first state and measured by the Rx modem 140, yielding the corresponding parameters. Next, the tuner 120 is set to the second state via the tuner measurement control word CW2, and the antenna 110 transmits a signal again. The receiving signal RS2 is generated via the tuner 120 in the second state and measured by the Rx modem 140, yielding the corresponding parameters.

To prevent internal channel changes, a RF signal receiving path PH1 in both the RF front-end circuit 130 and the Rx modem 140 should be fixed during the reception for all tuner measurement tuner control words CW1, CW2.

To prevent external channel changes, the receiving signals RS1, RS2, measured by receiver (Rx) for the tuner measurement control words CW1, CW2 should be measured within 1 microsecond in a real-time scenario.

Please refer to FIG. 2, which shows the tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2}$$

according to one embodiment of the present disclosure. The superscript “x” of the tuner scattering parameters

$${S}_{11}^{x} , {S}_{21}^{x} , {S}_{12}^{x} , {S}_{22}^{x}$$

represents the tuner measurement control word CWx. For example, the tuner scattering parameters

$${S}_{11}^{1} , {S}_{21}^{1} , {S}_{12}^{1} , {S}_{22}^{1} ,$$

are the reflection coefficients and transmission coefficients of the tuner 120 when the first tuner port P1 and the second tuner port P2 connect with 50Ω (Z₀) and the tuner 120 is set at the tuner measurement control word CW1; and the tuner scattering parameters

$${S}_{11}^{2} , {S}_{21}^{2} , {S}_{12}^{2} , {S}_{22}^{2} ,$$

are the reflection coefficients and transmission coefficients of the tuner 120 when the first tuner port P1 and the second tuner port P2 connect with 50Ω (Z₀) and the tuner 120 is set at the tuner measurement control word CW2. In some embodiments, the value of 50Ω for Z₀ is for illustrative purposes only. Z₀ can have any resistance value and is not limited to 50Ω (ohms). Z₀ can be other predetermined value.

The tuner scattering parameter

$${S}_{11}^{x} ( {S}_{11}^{1} or {S}_{11}^{2} )$$

is the reflection coefficient at a first tuner port P1, representing the proportion of the wave entering the first tuner port P1 that is reflected back to the first tuner port P1.

The tuner scattering parameter

$${S}_{21}^{x} ( {S}_{21}^{1} or {S}_{21}^{2} )$$

is the transmission coefficient from the first tuner port P1 to the second tuner port P2, representing the proportion of the wave entering the first tuner port P1 that is transmitted to the second tuner port P2.

The tuner scattering parameter

$${S}_{12}^{x} ( {S}_{12}^{1} or {S}_{12}^{2} )$$

is the transmission coefficient from the second tuner port P2 to the first tuner port P1, representing the proportion of the wave entering the second tuner port P2 that is transmitted to the tuner port P1.

The tuner scattering parameter

$${S}_{22}^{x} ( {S}_{22}^{1} or {S}_{22}^{2} )$$

is the reflection coefficient at the second tuner port P2, representing the proportion of the wave entering the second tuner port P2 that is reflected back to the second tuner port P2.

Please refer to FIG. 3, which shows the measurement of the tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2}$$

according to one embodiment of the present disclosure. The tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2}$$

could be estimated by using offline simulation or measured by equipment, such as but not limited to the vector network analyzer (VNA) 920.

One example of the measurement of the tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2}$$

includes disconnecting the tuner 120 with the RF front-end circuit 130 and the antenna 110, soldering the cables CB1, CB2 of the VNA 920 with the first tuner port P1 and the second tuner port P2 respectively; and measuring the tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2} .$$

For measuring the tuner scattering parameters

$${S}_{11}^{1} , {S}_{11}^{2} ,$$

a known signal is sent into the tuner 120 by a cable CB1 and the reflected signal is measured by the cable CB1.

For measuring the tuner scattering parameters

$${S}_{21}^{1} , {S}_{21}^{2} ,$$

a known signal is sent into the tuner 120 by the cable CB1 and the reflected signal is measured by a cable CB2.

For measuring the tuner scattering parameters

$${S}_{12}^{1} , {S}_{12}^{2} ,$$

a known signal is sent into the tuner 120 by the cable CB2 and the reflected signal is measured by the cable CB1.

For measuring the tuner scattering parameters

$${S}_{22}^{1} , {S}_{22}^{2} ,$$

a known signal is sent into the tuner 120 by the cable CB2 and the reflected signal is measured by the cable CB2.

Based on above, the tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2}$$

could be measured at offline.

Please refer to FIG. 4, which illustrates the front-end reflection coefficient Γ_{FE} according to one an embodiment of the present disclosure. The front-end reflection coefficient TFE is the reflection coefficient at an input port P3 of the RF front-end circuit 130, representing the proportion of the wave entering the input port P3 that is reflected back to the input port P3.

Please refer to FIG. 5, which illustrates the tuner reflection coefficient Γᵢₙ according to one an embodiment of the present disclosure. The tuner reflection coefficient Γᵢₙ is the reflection coefficient at the second tuner port P2, representing the proportion of the wave entering the second tuner port P2 that is reflected back to the second tuner port P2. The tuner reflection coefficient

$${Γ}_{i n}^{x}$$

can be derived by the front-end reflection coefficient Γ_{FE} and the tuner scattering parameters

$${S}_{11}^{x} , {S}_{21}^{x} , {S}_{12}^{x} , {S}_{22}^{x} .$$

For example, the tuner reflection coefficient

$${Γ}_{in}^{x} ( {Γ}_{in}^{1} , {Γ}_{in}^{2} )$$

could be obtain through the following equation (1).

$${Γ}_{in}^{x} = {S}_{22}^{x} + \frac{{S}_{12}^{x} {S}_{21}^{x} {Γ}_{FE}}{1 - {S}_{11}^{x} {Γ}_{FE}} \qquad ( 1 )$$

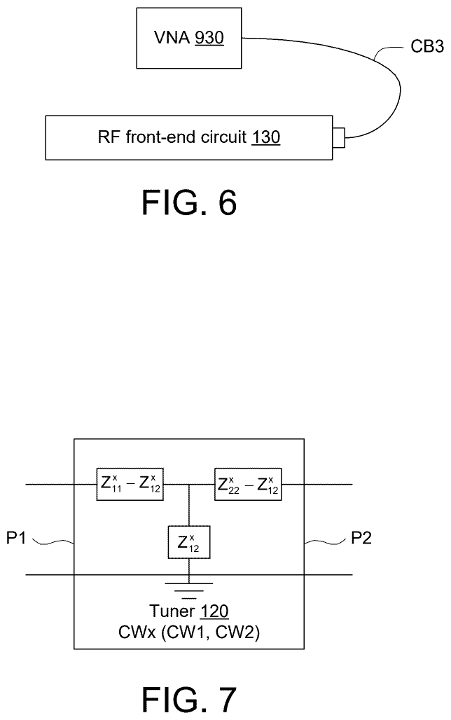

Please refer to FIG. 6, which shows the measurement of the front-end reflection coefficient Γ_{FE} according to one embodiment of the present disclosure. The front-end reflection coefficient Γ_{FE} could also be estimated by using offline simulation or measured by equipment, such as but not limited to a vector network analyzer (VNA) 930. An example of the measurement of the front-end reflection coefficient Γ_{FE} includes: disconnecting the RF front-end circuit 130 with the tuner 120; soldering the cable CB3 of the VNA 930 with the input port P3; and measuring the front-end reflection coefficient Γ_{FE} under the Rx frequency.

Based on above, the front-end reflection coefficient Γ_{FE} could be measured at offline.

Please refer to FIG. 7, which shows a tuner impedance matrix in the tuner 120 according to one embodiment of the present disclosure. Z_{FE} is an impedance of the RF front-end circuit 130 and could be derived by the front-end reflection coefficient Γ_{FE} through the following equation (2).

$${Z}_{FE} = {Z}_{0} ( \frac{1 + {Γ}_{FE}}{1 - {Γ}_{FE}} ) \qquad ( 2 )$$

$${Z}_{0} is 50 Ω .$$

As shown in the FIG. 7, the impedance matrix includes input impedances

$${Z}_{11}^{x} ( {Z}_{11}^{1} or {Z}_{11}^{2} ) ,$$

transfer impedances

$${Z}_{12}^{x} ( {Z}_{12}^{1} or {Z}_{12}^{2} ) ,$$

transfer impedances

$${Z}_{21}^{x} ( {Z}_{21}^{1} or {Z}_{21}^{2} ) ,$$

and input impedances

$${Z}_{22}^{x} ( {Z}_{22}^{1} or {Z}_{22}^{2} ) .$$

The superscript “x” of the input impedances

$${Z}_{11}^{x} , {Z}_{22}^{x}$$

and the transfer impedances

$${Z}_{12}^{x} , {Z}_{21}^{x}$$

represents the tuner measurement control word CWx.

The input impedances

$${Z}_{11}^{x} , {Z}_{22}^{x}$$

and the transfer impedances

$${Z}_{12}^{x} , {Z}_{21}^{x}$$

can be derived by the

$${S}_{11}^{x} , {S}_{21}^{x} , {S}_{12}^{x} , {S}_{22}^{x} .$$

The input impedance

$${Z}_{11}^{x}$$

is the input impedance at the first tuner port P1 when the second tuner port 2 is open-circuited. The input impedances

$${Z}_{11}^{x}$$

could be calculated through the following equation (3).

$${Z}_{11}^{x} = {Z}_{0} \frac{( 1 + {S}_{11}^{x} ) ( 1 - {S}_{22}^{x} ) + {S}_{12}^{x} {S}_{21}^{x}}{( 1 - {S}_{11}^{x} ) ( 1 - {S}_{22}^{x} ) - {S}_{12}^{x} {S}_{21}^{x}} \qquad ( 3 )$$

The transfer impedance

$${Z}_{12}^{x}$$

is the transfer impedance from the second tuner port P2 to the first tuner port P1 when the first tuner port 1 is open-circuited. The transfer impedance

$${Z}_{12}^{x}$$

could be calculated through the following equation (4).

$${Z}_{12}^{x} = {Z}_{0} \frac{2 {S}_{12}^{x}}{( 1 - {S}_{11}^{x} ) ( 1 - {S}_{22}^{x} ) - {S}_{12}^{x} {S}_{21}^{x}} \qquad ( 4 )$$

The transfer impedance

$${Z}_{21}^{x}$$

is the transfer impedance from the first tuner port P1 to the second tuner port P2 when the second tuner port P2 is open-circuited. The transfer impedance

$${Z}_{21}^{x}$$

could be calculated through the following equation (5).

$${Z}_{21}^{x} = {Z}_{0} \frac{2 {S}_{21}^{x}}{( 1 - {S}_{11}^{x} ) ( 1 - {S}_{22}^{x} ) - {S}_{12}^{x} {S}_{21}^{x}} \qquad ( 5 )$$

The input impedance

$${Z}_{22}^{x}$$

is the input impedance at the second tuner port P2 when the first tuner port P1 is open-circuited. The input impedance

$${Z}_{22}^{x}$$

could be calculated through the following equation (6).

$${Z}_{22}^{x} = {Z}_{0} \frac{( 1 - {S}_{11}^{x} ) ( 1 + {S}_{22}^{x} ) + {S}_{12}^{x} {S}_{21}^{x}}{( 1 - {S}_{11}^{x} ) ( 1 - {S}_{22}^{x} ) - {S}_{12}^{x} {S}_{21}^{x}} \qquad ( 6 )$$

The antenna reflection coefficient Γₐₙₜ could be calibrated by the following equation (7). In the equation (7), the root with |Γₐₙₜ|<1 is selected.

$${a}_{f} {Γ}_{ant}^{3} + {b}_{f} {Γ}_{ant}^{2} + {c}_{f} {Γ}_{ant} + {d}_{f} = 0 \qquad ( 7 )$$

According to the following equations (8) to (24), the coefficients a_{f}, b_{f}, c_{f}, d_{f} are functions of a receiving signal ratio Vᵣ, the tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2} ,$$

and the front-end reflection coefficient Γ_{FE}. The receiving signals RS1, RS2 are measured by the Rx modem 140.

$${V}_{r} = \frac{receiving signal RS 1}{receiving signal RS 2} \qquad ( 8 )$$

$${a}_{f} = {a}_{1} {a}_{4} {a}_{5} - {V}_{r} {a}_{2} {a}_{3} {a}_{6} \qquad ( 9 )$$

$${b}_{f} = ( {a}_{1} {a}_{4} {b}_{5} + {a}_{1} {b}_{4} {a}_{5} + {b}_{1} {a}_{4} {a}_{5} ) - {V}_{r} ( {a}_{2} {a}_{3} {b}_{6} + {a}_{2} {b}_{3} {a}_{6} + {b}_{2} {a}_{3} {a}_{6} ) \qquad ( 10 )$$

$${c}_{f} = ( {a}_{1} {b}_{4} {b}_{5} + {b}_{1} {b}_{4} {a}_{5} + {b}_{1} {a}_{4} {b}_{5} ) - {V}_{r} ( {a}_{2} {b}_{3} {b}_{6} + {b}_{2} {b}_{3} {a}_{6} + {b}_{2} {a}_{3} {b}_{6} ) \qquad ( 11 )$$

$${d}_{f} = {b}_{1} {b}_{4} {b}_{5} - {V}_{r} {b}_{2} {b}_{3} {b}_{6} \qquad ( 12 )$$

$${a}_{1} = {Z}_{0} ( - {S}_{22}^{2} - {S}_{11}^{2} {S}_{22}^{2} + {S}_{12}^{2} {S}_{21}^{2} ) + {Z}_{F E} ( - {S}_{22}^{2} + {S}_{11}^{2} {S}_{22}^{2} - {S}_{12}^{2} {S}_{21}^{2} ) \qquad ( 13 )$$

$${b}_{1} = {Z}_{0} ( 1 + {S}_{11}^{2} ) + {Z}_{F E} ( 1 - {S}_{11}^{2} ) \qquad ( 14 )$$

$${a}_{2} = - {S}_{22}^{2} + {S}_{11}^{2} {S}_{22}^{2} - {S}_{12}^{2} {S}_{21}^{2} \qquad ( 15 )$$

$${b}_{2} = 1 - {S}_{11}^{2} \qquad ( 16 )$$

$${a}_{3} = {Z}_{0} ( - {S}_{22}^{1} - {S}_{11}^{1} {S}_{22}^{1} + {S}_{12}^{1} {S}_{21}^{1} ) + {Z}_{F E} ( - {S}_{22}^{1} + {S}_{11}^{1} {S}_{22}^{1} - {S}_{12}^{1} {S}_{21}^{1} ) \qquad ( 17 )$$

$${b}_{3} = {Z}_{0} ( 1 + {S}_{11}^{1} ) + {Z}_{F E} ( 1 - {S}_{11}^{1} ) \qquad ( 18 )$$

$${a}_{4} = - {S}_{22}^{1} + {S}_{11}^{1} {S}_{22}^{1} - {S}_{12}^{1} {S}_{21}^{1} \qquad ( 19 )$$

$${b}_{4} = 1 - {S}_{11}^{1} \qquad ( 20 )$$

$${a}_{5} = - {Z}_{12}^{1} {Z}_{22}^{2} + {Z}_{12}^{1} {Z}_{0} \qquad ( 21 )$$

$${b}_{5} = {Z}_{12}^{1} {Z}_{22}^{2} + {Z}_{12}^{1} {Z}_{0} \qquad ( 22 )$$

$${a}_{6} = - {Z}_{12}^{2} {Z}_{22}^{1} + {Z}_{12}^{2} {Z}_{0} \qquad ( 23 )$$

$${b}_{6} = {Z}_{12}^{2} {Z}_{22}^{1} + {Z}_{12}^{2} {Z}_{0} \qquad ( 24 )$$

Please refer to FIG. 8, which illustrates the selection of the tuner measurement control words CW1, CW2 according to one embodiment of the present disclosure. The selection of the tuner measurement control words CW1, CW2 is highly dependent to the design of tuner RF hardware. To prevent receiving signal quality degradation, it is suggested, but not limit, to select the tuner measurement control words CW1, CW2 with insertion loss lower than 1 dB.

For example, the tuner 120 may be composed of a switch S1, and three variable capacitors D1, D2, and D3. When the switch S1 is turned on and the variable capacitors D1, D2, and D3 are turned off (or kept at low), the tuner 120 is controlled at the tuner measurement control word CW1. When the switch S1 is turned off, the variable capacitor D1 is turned on (or kept at high), and the variable capacitors D2, D3 are turned off (or kept at low), the tuner 120 is controlled at the tuner measurement control word CW2.

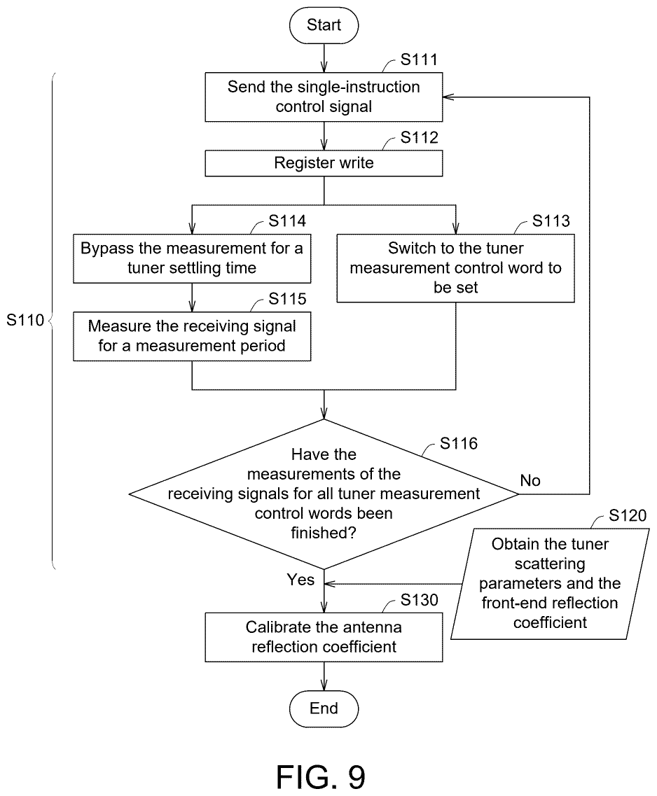

Please refer to FIG. 9, which shows a flowchart of a method for measuring the antenna reflection coefficient Γₐₙₜ of the antenna 110 according to one embodiment of the present disclosure. The method for measuring the antenna reflection coefficient Γₐₙₜ in the FIG. 9 includes steps S110 to S130. The step S110 includes steps S111 to S116.

In the step S110, as shown in the FIG. 1, the Rx modem 140 measures at least two receiving signals RS1, RS2. The at least two receiving signals RS1, RS2 are measured under different tuner measurement control words CW1, CW2 respectively. In the embodiment of the FIG. 9, a plurality of single-instruction control signals S11, S12 (ex. Mobile Industry Processor Interface (MIPI) signals) are sent to trigger the different tuner measurement control words CW1, CW2. In particular, switching to the tuner measurement control word CW1 is trigger by the single-instruction control signal S11; switching to the tuner measurement control word CW2 is trigger by the single-instruction control signal S12.

The resolution for the single-instruction control signals S11, S12 should be shorter than 0.5 microsec (0.5 subframe). Achieving the resolution level requires excessive software resources, such as DRAM.

The step S110 includes the steps S111 to S116. In the step S111, as shown in the FIG. 1, the SW control module 141 of the Rx modem 140 sends the single-instruction control signal S11 (or S12) to the tuner 120.

Next, in the step S112, as shown in the FIG. 1, the state machine module 121 of the tuner 120 writes the tuner measurement control word CW1 (or CW2) to a register.

Then, in the step S113, as shown in the FIG. 1, the tuner 120 switches to the tuner measurement control word CW1 (or CW2) to be set and waits for finishing the steps S114 and S115.

At the same time, in the step S114, as shown in the FIG. 1, the Rx modem 140 bypasses the measurement for a tuner settling time, such as A us (any positive number of microseconds).

Afterwards, in the step S115, as shown in the FIG. 1, the Rx modem 140 measures the receiving signal RS1 (or RS2) for a measurement period, such as B us (any positive number of microseconds).

Then, in the step S116, as shown in the FIG. 1, the Rx modem 140 determines whether the measurements of the receiving signals RS1, RS2 for all tuner measurement control words CW1, CW2 have been finished. If the measurements of the receiving signals RS1, RS2 for all tuner measurement control words CW1, CW2 have been finished, the process proceeds to the step S130; if the measurements of the receiving signals RS1, RS2 for all tuner measurement control words CW1, CW2 have not been finished yet, the process proceeds to the step S111.

Before proceeding to the step S130, the step S120 is executed. In the step S120, the Rx modem 140 obtains the tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2}$$

and the front-end reflection coefficient Γ_{FE}.

Next, in the step S130, the Rx modem 140 calibrates the antenna reflection coefficient Γₐₙₜ according to the at least two receiving signals RS1, RS2, the tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2}$$

and the front-end reflection coefficient Γ_{FE}. In this step, the antenna reflection coefficient Γₐₙₜ is calibrated by

$${a}_{f} {Γ}_{a n t}^{3} + {b}_{f} {Γ}_{a n t}^{2} + {c}_{f} {Γ}_{a n t} + {d}_{f} = 0$$

(the equation (1) described above).

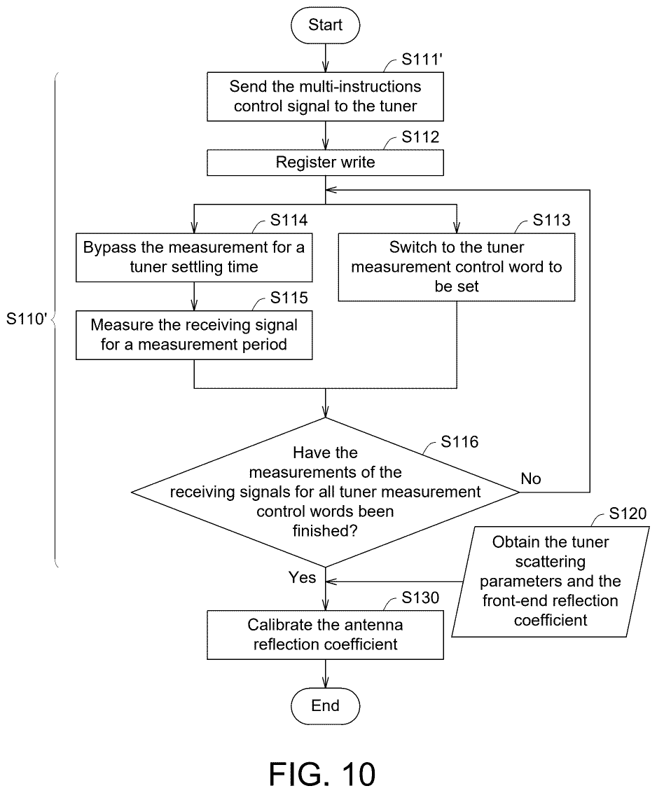

Please refer to FIG. 10, which shows a flowchart of a method for measuring the antenna reflection coefficient Γₐₙₜ of the antenna 110 according to another embodiment of the present disclosure. The method for measuring the antenna reflection coefficient Γₐₙₜ in the FIG. 10 includes steps S110′, S120 and S130. The step S110′ includes steps S111′ and S112 to S116. In the embodiment of the FIG. 10, a multi-instructions control signal S2 (ex. Mobile Industry Processor Interface (MIPI) signal) is sent to trigger an automatic tuner measurement control word switching. The tuner setting is switched multiple times by multi-instructions control signal S2, so that an acceptable low software control resolution could be obtained.

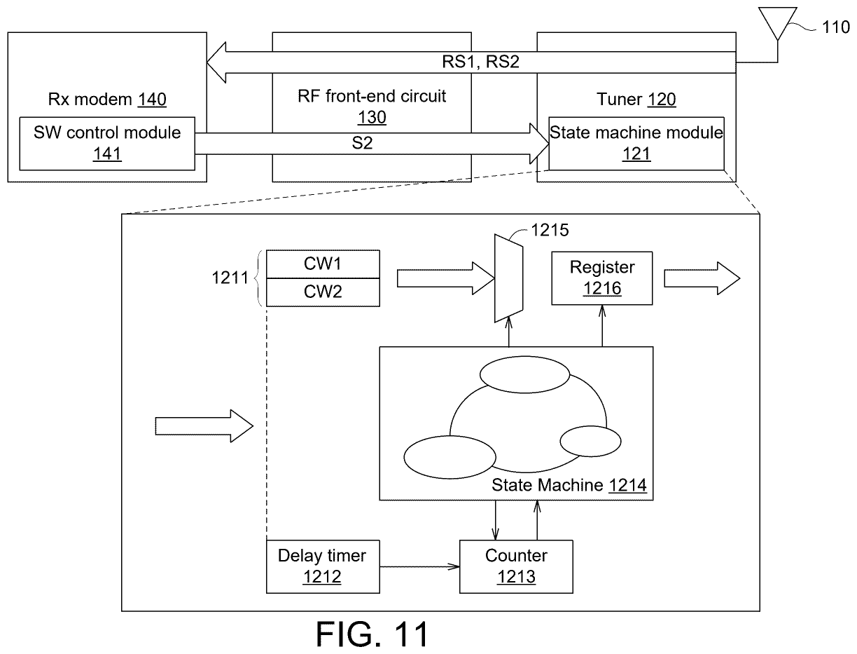

Please refer to FIGS. 10 and 11. FIG. 11 illustrates the hardware features for executing the automatic tuner measurement control word switching according to one embodiment of the present disclosure. As shown in the FIG. 11, the state machine module 121 of the tuner 120 may comprise a register 1211, a delay timer 1212, a counter 1213, a state machine 1214, a MUX 1215 and a register 1216.

In step S110′, as shown in the FIG. 11, the Rx modem 140 measures the at least two receiving signals RS1, RS2. The at least two receiving signals RS1, RS2 are measured under different tuner measurement control words CW1, CW2.

The step S110′ includes the steps S111′ and S112 to S116. In the step S111′, as shown in the FIG. 11, the SW control module 141 of the Rx modem 140 sends the multi-instructions control signal S2 to the tuner 120.

Next, in the step S112, as shown in the FIG. 11, the state machine module 121 of the tuner 120 writes the tuner measurement control words CW1 and CW2 to the register 1211.

Then, in the step S113, as shown in the FIG. 11, the tuner 120 switches to the tuner measurement control word CW1 (or CW2) to be set and waits for finishing the steps S114 and S115.

At the same time, in the step S114, as shown in the FIG. 11, the Rx modem 140 bypasses the measurement for the tuner settling time, such as A us.

Afterwards, in the step S115, as shown in the FIG. 11, the Rx modem 140 measures the receiving signal RS1 (or RS2) for the measurement period, such as B us.

Then, in the step S116, as shown in the FIG. 11, the Rx modem 140 determines whether the measurements of the receiving signals RS1, RS2 for all tuner measurement control words CW1, CW2 have been finished. If the measurements of the receiving signals RS1, RS2 for all tuner measurement control words CW1, CW2 have been finished, the process proceeds to the step S130; if the measurements of the receiving signals RS1, RS2 for all tuner measurement control words CW1, CW2 have not been finished yet, the process proceeds to the steps S113 and S114.

Before proceeding to the step S130, the step S120 is executed. In the step S120, the Rx modem 140 obtains the tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2}$$

and the front-end reflection coefficient Γ_{FE}.

Next, in the step S130, the Rx modem 140 calibrates the antenna reflection coefficient Γₐₙₜ according to the at least two receiving signals RS1, RS2, the tuner scattering parameters

$${S}_{11}^{1} , {S}_{11}^{2} , {S}_{21}^{1} , {S}_{21}^{2} , {S}_{12}^{1} , {S}_{12}^{2} , {S}_{22}^{1} , {S}_{22}^{2}$$

and the front-end reflection coefficient Γ_{FE}. In this step, the antenna reflection coefficient Γₐₙₜ is calibrated by

$${a}_{f} {Γ}_{ant}^{3} + {b}_{f} {Γ}_{ant}^{2} + {c}_{f} {Γ}_{ant} + {d}_{f} = 0$$

(the equation (1) described above).

Based on above, the automatic tuner measurement control word switching is executed to gain some benefits. For example, a programmable way is allowed to perform the calibrations with low control overhead. This is achieved by programming the calibration sequence in advance and triggering the calibration function to operate. The high demand software calculations could be performed in advance and set as parameters during periods of low control traffic. Only a low traffic trigger is required to start the calibration.

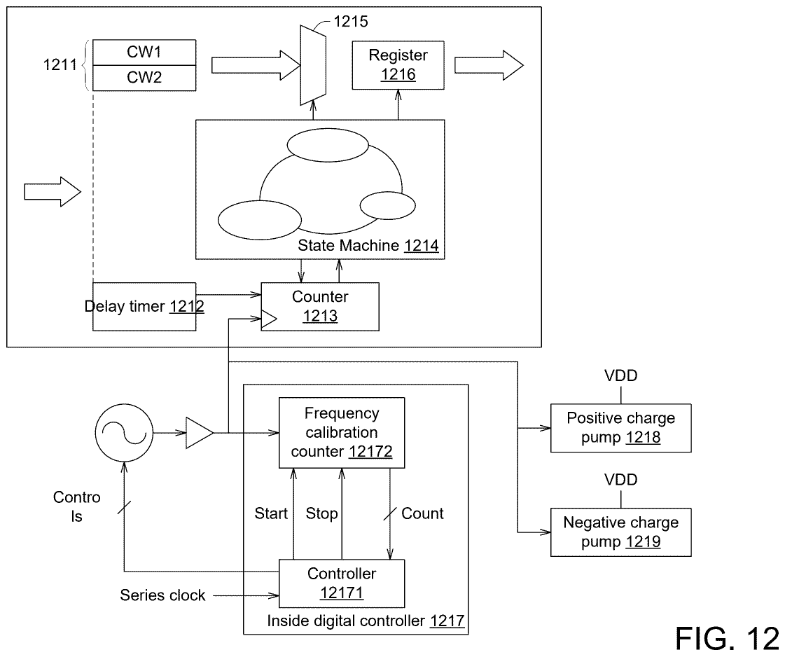

Please refer to FIG. 12, which illustrates a clock calibration for the automatic tuner measurement control word switching according to one embodiment of the present disclosure. To execute the clock calibration, an inside digital controller 1227, a positive charge pump 1228 and a negative charge pump 1229 could be used. The inside digital controller 1227 includes a controller 12271 and a frequency calibration counter 12272. The clock calibration improves timing control accuracy, which is especially important for a self-timed system with high process variability. In the FIG. 12, an implementation example for the clock calibration is provided by using internal clock source. For example, the tuner 120 inherently incorporates an oscillator within their design. The presence of the oscillator is essential for the operation of a charge pump (the positive charge pump 1218 or the negative charge pump 1219). Consequently, there is no necessity for additional circuitry. This approach effectively reutilizes substantial portions of the existing architecture.

Further, a continuous serial clock could be provided as part of successive writes to dummy registers through the feature of extended write supported by MIPI RFFE.

According to the embodiments described above, the measurement of the antenna reflection coefficient Γ_{Ant} utilizes the receiving signals RS1, RS2. This innovative approach enables the implementation of close-loop antenna tuning (CLAT) across all antennas in mobile devices, irrespective of their connection to the Tx. By leveraging the received signal for measurement, this method overcomes the traditional limitations and enhances the tuning precision and efficiency of mobile antennas. Further, the measurement could not suffer from variation, such as part-to-part variation and temperature change. Moreover, the antenna reflection coefficient Γₐₙₜ could be directly measured under Rx frequency in real-time scenario.

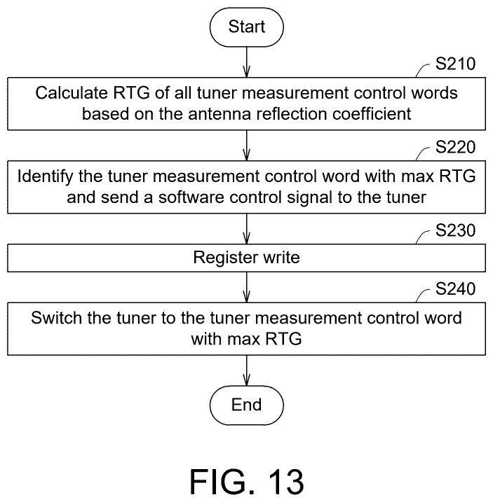

Please refer to FIG. 13, which illustrates Receiver Close-Loop Antenna Tuning (RxCLAT) according to one embodiment of the present disclosure. RxCLAT is a new technique for automatically controlling source impedance through switching tuner measurement control words for the receiver, maximizing the received power. RxCLAT requires estimating the gain enhancement provided by the antenna tuner for each tuner measurement control word CWx through real-time measurement of the antenna reflection coefficient f_{A}nt.

One approach (but not limited to) for estimating the gain enhancement by the antenna tuner for each tuner measurement control word CWx is to calculate the relative transducer gain (RTG) according to the following equation (25).

$$R T G = \frac{{G}_{T}}{{G}_{T , thru}} = \frac{{\vert {S}_{12} \vert}^{2} {\vert 1 - {Γ}_{FE} {Γ}_{Ant} \vert}^{2}}{{\vert 1 - {Γ}_{Ant} {Γ}_{in} \vert}^{2} {\vert 1 - {S}_{11} {Γ}_{FE} \vert}^{2}} \qquad ( 25 )$$

G_{T} is the transducer gain with tuner, which is calculated by the following equation (26).

$${G}_{T} = \frac{Power delivered to the R F F E}{Available source power} = \frac{{\vert {S}_{12} \vert}^{2} ( 1 - {\vert {Γ}_{Ant} \vert}^{2} ) ( 1 - {\vert {Γ}_{FE} \vert}^{2} )}{{\vert 1 - {Γ}_{Ant} {Γ}_{in} \vert}^{2} {\vert 1 - {S}_{11} {Γ}_{FE} \vert}^{2}} \qquad ( 26 )$$

G_{T,thru} is the transducer gain without tuner, so S₁₂=1, S₁₁=0. G_{T,thru} is calculated through the following equation (27).

$${G}_{T , thru} = \frac{( 1 - {\vert {Γ}_{Ant} \vert}^{2} ) ( 1 - {\vert {Γ}_{FE} \vert}^{2} )}{{\vert 1 - {Γ}_{Ant} {Γ}_{in} \vert}^{2}} \qquad ( 27 )$$

As shown in the FIG. 13, the procedure for executing the RxCLAT includes, for example, steps S210 to S240.

In the step S210, the Rx modem 140 calculates the RTG of all tuner measurement control words CWx based on the antenna reflection coefficient Γ_{Ant}.

Next, in the step S220, the SW control module 141 identifies the tuner measurement control word CWx with max RTG and send a software control signal to the tuner 120.

Then, in the step S230, the state machine module 121 of the tuner 120 writes the tuner measurement control word CWx to a register.

Afterwards, in the step S240, the tuner 120 is switched to the tuner measurement control word CWx with max RTG.

Based on this procedure, the received power could be maximized through switching the tuner measurement control word CWx.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method for measuring an antenna reflection coefficient of an antenna, comprising:
measuring at least two receiving signals, wherein the at least two receiving signals are measured under different tuner measurement control words respectively;
obtaining a plurality of tuner scattering parameters and a front-end reflection coefficient under a receiver (Rx) frequency, wherein the plurality of tuner scattering parameters correspond to the different tuner measurement control words; and
calibrating the antenna reflection coefficient according to the at least two receiving signals, the tuner scattering parameters and the front-end reflection coefficient.

2. The method according to claim 1, wherein the at least two receiving signals are measured offline, real-time, or in a hybrid mode.

3. The method according to claim 2, wherein switching between the different tuner measurement control words is controlled by a plurality of single-instruction control signals or is controlled by a multi-instructions control signal.

4. The method according to claim 3, wherein each of the single-instruction control signals and the multi-instructions signal is a Mobile Industry Processor Interface signal.

5. The method according to claim 1, wherein when measuring the at least two receiving signals, a RF signal receiving path for receiving the at least two receiving signals is fixed.

6. The method according to claim 1, wherein the tuner scattering parameters are measured by using offline simulation or by equipment, and the equipment comprises a vector network analyzer (VNA).

7. The method according to claim 1, wherein the front-end reflection coefficient is measured by using offline simulation or by equipment, and the equipment comprises a vector network analyzer (VNA).

8. The method according to claim 1, wherein the antenna is connected to at least one receiver.

9. The method according to claim 1, wherein
in the step of calibrating the antenna reflection coefficient, the antenna reflection coefficient is calibrated by
$${a}_{f} {Γ}_{ant}^{3} + {b}_{f} {Γ}_{ant}^{2} + {c}_{f} {Γ}_{ant} + {d}_{f} = 0 ;$$
Γₐₙₜ is the antenna reflection coefficient;
$${a}_{f} = {a}_{1} {a}_{4} {a}_{5} - {V}_{r} {a}_{2} {a}_{3} {a}_{6} ;$$
$${b}_{f} = ( {a}_{1} {a}_{4} {b}_{5} + {a}_{1} {b}_{4} {a}_{5} + {b}_{1} {a}_{4} {a}_{5} ) - {V}_{r} ( {a}_{2} {a}_{3} {b}_{6} + {a}_{2} {b}_{3} {a}_{6} + {b}_{2} {a}_{3} {a}_{6} ) ;$$
$${c}_{f} = ( {a}_{1} {b}_{4} {b}_{5} + {b}_{1} {b}_{4} {a}_{5} + {b}_{1} {a}_{4} {b}_{5} ) - {V}_{r} ( {a}_{2} {b}_{3} {b}_{6} + {b}_{2} {b}_{3} {a}_{6} + {b}_{2} {a}_{3} {b}_{6} ) ;$$
$${d}_{f} = {b}_{1} {b}_{4} {b}_{5} - {V}_{r} {b}_{2} {b}_{3} {b}_{6} ;$$
$${V}_{r} = \frac{RS 1}{RS 2} ;$$
RS1 and RS2 are the at least two receiving signals, and the receiving signals are measured under the different tuner measurement control words;
$${a}_{1} = {Z}_{0} ( - {S}_{22}^{2} - {S}_{11}^{2} {S}_{22}^{2} + {S}_{12}^{2} {S}_{21}^{2} ) + {Z}_{FE} ( - {S}_{22}^{2} + {S}_{11}^{2} {S}_{22}^{2} - {S}_{12}^{2} {S}_{21}^{2} ) ;$$
$${b}_{1} = {Z}_{0} ( 1 + {S}_{11}^{2} ) + {Z}_{FE} ( 1 - {S}_{11}^{2} ) ;$$
$${a}_{2} = - {S}_{22}^{2} + {S}_{11}^{2} {S}_{22}^{2} - {S}_{12}^{2} {S}_{21}^{2} ;$$
$${b}_{2} = 1 - {S}_{11}^{2} ;$$
$${a}_{3} = {Z}_{0} ( - {S}_{22}^{1} - {S}_{11}^{1} {S}_{22}^{1} + {S}_{12}^{1} {S}_{21}^{1} ) + {Z}_{FE} ( - {S}_{22}^{1} + {S}_{11}^{1} {S}_{22}^{1} - {S}_{12}^{1} {S}_{21}^{1} ) ;$$
$${b}_{3} = {Z}_{0} ( 1 + {S}_{11}^{1} ) + {Z}_{FE} ( 1 - {S}_{11}^{1} ) ;$$
$${a}_{4} = - {S}_{22}^{1} + {S}_{11}^{1} {S}_{22}^{1} - {S}_{12}^{1} {S}_{21}^{1} ;$$
$${b}_{4} = 1 - {S}_{11}^{1} ;$$
$${a}_{5} = - {Z}_{12}^{1} {Z}_{22}^{2} + {Z}_{12}^{1} {Z}_{0} , {b}_{5} = {Z}_{12}^{1} {Z}_{22}^{2} + {Z}_{12}^{1} {Z}_{0} , {a}_{6} = - {Z}_{12}^{2} {Z}_{22}^{1} + {Z}_{12}^{2} {Z}_{0} ;$$
$${b}_{6} = {Z}_{12}^{2} {Z}_{22}^{1} + {Z}_{12}^{2} {Z}_{0} ;$$
$${S}_{11}^{1} , {S}_{11}^{2} , {S}_{21}^{1} , {S}_{21}^{2} , {S}_{12}^{1} , {S}_{12}^{2} , {S}_{22}^{1} , and {S}_{22}^{2}$$
are the tuner scattering parameters corresponding to the different tuner measurement control words;
$${S}_{11}^{1} and {S}_{11}^{2}$$
are reflection coefficients at a first tuner port under the different tuner measurement control words, representing proportion of a wave entering the first tuner port that are reflected back to the first tuner port under the different tuner measurement control words;
$${S}_{21}^{1} and {S}_{21}^{2}$$
are transmission coefficients from the first tuner port to a second tuner port under the different tuner measurement control words, representing proportion of a wave entering the first tuner port that are transmitted to the second tuner port under the different tuner measurement control words;
$${S}_{12}^{1} and {S}_{12}^{2}$$
are transmission coefficients from the second tuner port to the first tuner port under the different tuner measurement control words, representing proportion of a wave entering the second tuner port that are transmitted to the first tuner port under the different tuner measurement control words;
$${S}_{22}^{1} and {S}_{22}^{2}$$
are reflection coefficients at the second tuner port under the different tuner measurement control words, representing proportion of a wave entering the second tuner port that are reflected back to the second tuner port under the different tuner measurement control words;
$${Z}_{11}^{1} and {Z}_{11}^{2}$$
are input impedances at the first tuner port when the second tuner port is open-circuited;
$${Z}_{12}^{1} and {Z}_{12}^{2}$$
are transfer impedances from the second tuner port to the first tuner port when the first tuner port is open-circuited;
$${Z}_{21}^{1} and {Z}_{21}^{2}$$
are transfer impedances from the first tuner port to the second tuner port when the second tuner port is open-circuited;
$${Z}_{22}^{1} and {Z}_{22}^{2}$$
are input impedances at the second tuner port when the first tuner port is open-circuited; and
Z₀ is 50, Z_{FE} is an impedance of a RF front-end circuit and is derived by Γ_{FE}, and Γ_{FE} is the front-end reflection coefficient.

10. A user equipment, comprising:
an antenna, having an antenna reflection coefficient;
a tuner, connected to the antenna, wherein the tuner is used for switching different tuner measurement control words;
an RF Front-end circuit, connected to the tuner; and
a receiving (Rx) modem, connected to the RF Front-end circuit, wherein the Rx modem is used for measuring at least two receiving signals, the at least two receiving signals are measured under different tuner measurement control words respectively, and the Rx modem is used for calibrating the antenna reflection coefficient according to the at least two receiving signals, a plurality of tuner scattering parameters and a front-end reflection coefficient.

11. The user equipment according to claim 10, wherein the at least two receiving signals are measured offline, real-time, or in a hybrid mode.

12. The user equipment according to claim 11, wherein the tuner switches between the different tuner measurement control words by a plurality of single-instruction control signals or by a multi-instructions control signal.

13. The user equipment according to claim 12, wherein each of the single-instruction signals and the multi-instructions signal is a Mobile Industry Processor Interface signal.

14. The user equipment according to claim 10, wherein when the Rx modem measures the at least two receiving signals, a RF signal receiving path for receiving the at least two receiving signals is fixed.

15. The user equipment according to claim 10, wherein the tuner scattering parameters are measured by using offline simulation or by equipment, and the equipment comprises a vector network analyzer (VNA).

16. The user equipment according to claim 10, wherein the front-end reflection coefficient is measured by using offline simulation or by equipment, and the equipment comprises a vector network analyzer (VNA).

17. The user equipment according to claim 10, wherein the antenna is connected to at least one receiver.

18. The user equipment according to claim 10, wherein the Rx modem calibrates the antenna reflection coefficient by
$${a}_{f} {Γ}_{a n t}^{3} + {b}_{f} {Γ}_{a n t}^{2} + {c}_{f} {Γ}_{a n t} + {d}_{f} = 0 ;$$
Γₐₙₜ is the antenna reflection coefficient;
$${a}_{f} = {a}_{1} {a}_{4} {a}_{5} - {V}_{r} {a}_{2} {a}_{3} {a}_{6} ;$$
$${b}_{f} = ( {a}_{1} {a}_{4} {b}_{5} + {a}_{1} {b}_{4} {a}_{5} + {b}_{1} {a}_{4} {a}_{5} ) - {V}_{r} ( {a}_{2} {a}_{3} {b}_{6} + {a}_{2} {b}_{3} {a}_{6} + {b}_{2} {a}_{3} {a}_{6} ) ;$$
$${c}_{f} = ( {a}_{1} {b}_{4} {b}_{5} + {b}_{1} {b}_{4} {a}_{5} + {b}_{1} {a}_{4} {b}_{5} ) - {V}_{r} ( {a}_{2} {b}_{3} {b}_{6} + {b}_{2} {b}_{3} {a}_{6} + {b}_{2} {a}_{3} {b}_{6} ) ;$$
$${d}_{f} = {b}_{1} {b}_{4} {b}_{5} - {V}_{r} {b}_{2} {b}_{3} {b}_{6} ;$$
$${V}_{r} = \frac{R S 1}{R S 2} ;$$
RS1 and RS2 are the at least two receiving signals, and the receiving signals are measured under the different tuner measurement control words;
$${a}_{1} = {Z}_{0} ( - {S}_{22}^{2} - {S}_{11}^{2} {S}_{22}^{2} + {S}_{12}^{2} {S}_{21}^{2} ) + {Z}_{F E} ( - {S}_{22}^{2} + {S}_{11}^{2} {S}_{22}^{2} - {S}_{12}^{2} {S}_{21}^{2} ) ;$$
$${b}_{1} = {Z}_{0} ( 1 + {S}_{11}^{2} ) + {Z}_{F E} ( 1 - {S}_{11}^{2} ) ;$$
$${a}_{2} = - {S}_{22}^{2} + {S}_{11}^{2} {S}_{22}^{2} - {S}_{12}^{2} {S}_{21}^{2} ;$$
$${b}_{2} = 1 - {S}_{11}^{2} ;$$
$${a}_{3} = {Z}_{0} ( - {S}_{22}^{1} - {S}_{11}^{1} {S}_{22}^{1} + {S}_{12}^{1} {S}_{21}^{1} ) + {Z}_{F E} ( - {S}_{22}^{1} + {S}_{11}^{1} {S}_{22}^{1} - {S}_{12}^{1} {S}_{21}^{1} ) ;$$
$${b}_{3} = {Z}_{0} ( 1 + {S}_{11}^{1} ) + {Z}_{F E} ( 1 - {S}_{11}^{1} ) ;$$
$${a}_{4} = - {S}_{22}^{1} + {S}_{11}^{1} {S}_{22}^{1} - {S}_{12}^{1} {S}_{21}^{1} ;$$
$${b}_{4} = 1 - {S}_{11}^{1} ;$$
$${a}_{5} = - {Z}_{12}^{1} {Z}_{22}^{2} + {Z}_{12}^{1} {Z}_{0} , {b}_{5} = {Z}_{12}^{1} {Z}_{22}^{2} + {Z}_{12}^{1} {Z}_{0} , {a}_{6} = - {Z}_{12}^{2} {Z}_{22}^{1} + {Z}_{12}^{2} {Z}_{0} ;$$
$${b}_{6} = {Z}_{12}^{2} {Z}_{22}^{1} + {Z}_{12}^{2} {Z}_{0} ;$$
$${S}_{11}^{1} , {S}_{11}^{2} , {S}_{21}^{1} , {S}_{21}^{2} , {S}_{12}^{1} , {S}_{12}^{2} , {S}_{22}^{1} , and {S}_{22}^{2}$$
are the tuner scattering parameters corresponding to the different tuner measurement control words;
$${S}_{11}^{1} and {S}_{11}^{2}$$
are reflection coefficients at a first tuner port under the different tuner measurement control words, representing proportion of a wave entering the first tuner port that are reflected back to the first tuner port under the different tuner measurement control words;
$${S}_{21}^{1} and {S}_{21}^{2}$$
are transmission coefficients from the first tuner port to a second tuner port under the different tuner measurement control words, representing proportion of a wave entering the first tuner port that are transmitted to the second tuner port under the different tuner measurement control words;
$${S}_{12}^{1} and {S}_{12}^{2}$$
are transmission coefficients from the second tuner port to the first tuner port under the different tuner measurement control words, representing proportion of a wave entering the second tuner port that are transmitted to the first tuner port under the different tuner measurement control words;
$${S}_{22}^{1} and {S}_{22}^{2}$$
are reflection coefficients at the second tuner port under the different tuner measurement control words, representing proportion of a wave entering the second tuner port that are reflected back to the second tuner port under the different tuner measurement control words;
$${Z}_{11}^{1} and {Z}_{11}^{2}$$
are input impedances at the first tuner port when the second tuner port is open-circuited;
$${Z}_{12}^{1} and {Z}_{12}^{2}$$
are transfer impedances from the second tuner port to the first tuner port when the first tuner port is open-circuited;
$${Z}_{21}^{1} and {Z}_{21}^{2}$$
are transfer impedances from the first tuner port to the second tuner port when the second tuner port is open-circuited;
$${Z}_{22}^{1} and {Z}_{22}^{2}$$
are input impedances at the second tuner port when the first tuner port is open-circuited; and
Z₀ is 50, Z_{FE} is an impedance of the RF front-end circuit and is derived by Γ_{FE}, and Γ_{FE} is the front-end reflection coefficient.
